(19) United States
(12) Patent Application Publication
(10) Pub. No.: US 2017/0277535 A1
(43) Pub. Date: Sep. 28, 2017

(54) TECHNIQUES FOR RESTORING PREVIOUS VALUES TO REGISTERS OF A PROCESSOR REGISTER FILE

(71) Applicant: INTERNATIONAL BUSINESS MACHINES CORPORATION, Armonk, NY (US)

(72) Inventors: HUNG Q. LE, Austin, TX (US); DAVID S. LEVITAN, Austin, TX (US); DUNG Q. NGUYEN, Austin, TX (US); ALBERT J. VAN NORSTRAND, JR., Round Rock, TX (US)

(21) Appl. No.: 15/079,151

(22) Filed: Mar. 24, 2016

(51) Int. Cl. G06F 9/30; G06F 9/38

(52) U.S. Cl. CPC G06F 9/3005; G06F 9/3867

(57) ABSTRACT

A technique for operating a processor includes receiving, by a history buffer, a flush tag associated with an oldest instruction to be flushed from a processor pipeline. In response to the flush tag being older than a first instruction tag that identifies a first instruction associated with a current value stored in a register of the register file and younger than a second instruction tag that identifies a second instruction associated with a previous value that was stored in the register of the register file, the history buffer transfers the previous value for the register to the register file. In response to the flush tag not being older than the first instruction tag and younger than the second instruction tag, the history buffer does not transfer the previous value for the register to the register file (as such, the register maintains the current value following a pipeline flush).

### BACKGROUND

The disclosure generally relates to processor register files, and more particularly, to techniques for restoring previous values to registers of a processor register file in a simultaneous multithreading data processing system.

In general, on-chip parallelism of a processor design may be increased through superscalar techniques that attempt to exploit instruction level parallelism (ILP) and/or through multithreading, which attempts to exploit thread level parallelism (TLP). Superscalar refers to executing multiple instructions at the same time, and multithreading refers to executing instructions from multiple threads within one processor chip at the same time. Simultaneous multithreading (SMT) is a technique for improving the overall efficiency of superscalar processors with hardware multithreading. In general, SMT permits multiple independent threads of execution to better utilize resources provided by modern processor architectures. In SMT, the pipeline stages are time shared between active threads.

In computer science, a thread of execution (or thread) is usually the smallest sequence of programmed instructions that can be managed independently by an operating system (OS) scheduler. A thread is usually considered a light-weight process, and the implementation of threads and processes usually differs between OSs, but in most cases a thread is included within a process. Multiple threads can exist within the same process and share resources, e.g., memory, while different processes usually do not share resources. In a processor with multiple processor cores, each processor core may execute a separate thread simultaneously. In general, a kernel of an OS allows programmers to manipulate threads via a system call interface.

In various out-of-order processor architectures, history buffers have been implemented in combination with register files to facilitate speculative instruction execution. As is known, a history buffer may be used to store ‘old’ previous values of registers that have been overwritten with ‘new’ current values. In general, when a pipeline flush occurs, e.g., due to a branch misprediction, previous values for effected registers must be restored (i.e., copied back) to a register file. In processor architectures that have implemented multiple history buffers, restoring a previous value to a register is complicated as multiple history buffer restores are required to occur in parallel and at least some previous values from the history buffers may be directed to a same register. Restoring a previous value to a register of a register file has required all previous values (even previous values that do not correspond to a final register state after the restore) to be sent from each history buffer to the register file. Restoring a previous value to a register of a register file has also required determining which previous value should be used to restore the register, since in processors implementing multiple history buffers all of the history buffers may be providing respective previous values for a same register in a same cycle

### BRIEF SUMMARY

A technique for operating a processor includes receiving, by a history buffer, a flush tag associated with an oldest instruction to be flushed from a processor pipeline. In response to the flush tag being older than a first instruction tag that identifies a first instruction associated with a current value stored in a register of a register file and younger than a second instruction tag that identifies a second instruction associated with a previous value that was stored in the register of the register file, the history buffer transfers the previous value for the register to the register file. In response to the flush tag not being older than the first instruction tag and younger than the second instruction tag, the history buffer does not transfer the previous value for the register to the register file (as such, the register maintains the current value following a pipeline flush).

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a diagram of a relevant portion of an exemplary data processing system environment that includes a simultaneous multithreading (SMT) data processing system that is configured to restore previous values to registers of a register file according to the present disclosure;

FIG. 2 is a diagram of a relevant portion of an exemplary processor pipeline of the data processing system of FIG. 1;

FIG. 3 is a diagram of a relevant portion of an exemplary instruction sequencing unit (ISU) that is configured to restore previous values to registers of a register file according to the present disclosure;

FIG. 4 is a diagram of a relevant portion of an exemplary ISU used to illustrate the operation of the ISU according to the present disclosure;

FIG. 5 is another diagram of a relevant portion of an exemplary ISU used to illustrate the operation of the ISU according to the present disclosure;

FIG. 6 is yet another diagram of a relevant portion of an exemplary ISU used to illustrate the operation of the ISU according to an embodiment of the present disclosure;

FIG. 7 is a flowchart of an exemplary process implemented by write logic associated with a register file configured according to one embodiment of the present disclosure; and

FIG. 8 is a flowchart of an exemplary process implemented by restore logic associated with a history buffer configured according to one embodiment of the present disclosure.

### DETAILED DESCRIPTION

The illustrative embodiments provide a method, a data processing system, and a processor configured to restore previous values to registers of a register file in a simultaneous multithreading data processing system following a processor pipeline flush.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It should be understood that the use of specific component, device, and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As used herein, the term ‘coupled’ may encompass a direct connection between components or elements or an indirect connection between components or elements utilizing one or more intervening components or elements.

The present disclosure is generally directed to processor architectures in which multiple history buffers (e.g., one for each pipeline slice, may be utilized to restore registers (e.g., architected registers) of a register file (e.g., an architected register file) following a processor pipeline flush. It should be appreciated that in processor architectures that employ history buffers, when an instruction needs to speculatively update a register, a previous value of the register is stored in the history buffer and the register is updated with a speculative value. In at least one processor architecture, an instruction identifier (e.g., an instruction tag (ITAG)) has been used to track each in-flight instruction. In this case, a history buffer has been configured to send a previous value from each history buffer entry to a register file in response to a pipeline flush (e.g., due to a branch misprediction). The register file was then configured to determine an oldest restore value (i.e., a previous value closest to (but older than) the flush point) for each register that required restoring.

As previously mentioned, in processor architectures that have implemented multiple history buffers, restoring a previous value to a register is further complicated as multiple history buffer restores are required to occur in parallel and at least some previous values from the history buffers may be directed to a same register. Restoring a previous value to a register of a register file has required all previous values (even previous values that do not correspond to a final register state after the restore) to be sent from each history buffer to the register file. Restoring a previous value to a register of a register file has also required determining which previous value should be used to restore the register, since in processors implementing multiple history buffers all of the history buffers may be providing respective previous values for a same register in a same cycle.

According to the present disclosure, techniques are disclosed that save additional information in association with each previous value to accurately identify history buffer entries that are required to be restored in response to a pipeline flush. In general, the disclosed techniques may avoid extra writes from a history buffer for each register to be restored that have increased pipeline flush restore latency. The disclosed techniques also facilitate avoiding the need for a register file to resolve multiple restores from a history buffer to each register to be restored.

According to one embodiment of the present disclosure, an ITAG of a first instruction (e.g., a first ITAG) that is updating a register and an ITAG of a second instruction (e.g., a second ITAG) that created a previous value to be stored in a history buffer are saved in association with each history buffer entry. In this case, a previous value (and associated ITAG) stored in a history buffer only needs to be restored to a register if a flush ITAG (i.e., an ITAG of the oldest instruction that is flushed) is older than the first ITAG of the first instruction that updated the register and the flush ITAG is younger than the second ITAG of the second instruction that created the previous value. By performing two compares instead of one compare only one history buffer restore occurs for each register of a register file that requires restoring. From a cycle time perspective the disclosed techniques advantageously avoid the need for a register file to compare all history buffer restores against each other, which simplifies restoring a previous register state and avoids a potential cycle time critical path. Additionally, a restore can occur in fewer cycles as there are fewer writes from each history buffer which results in a faster pipeline flush recovery and improved processor performance.

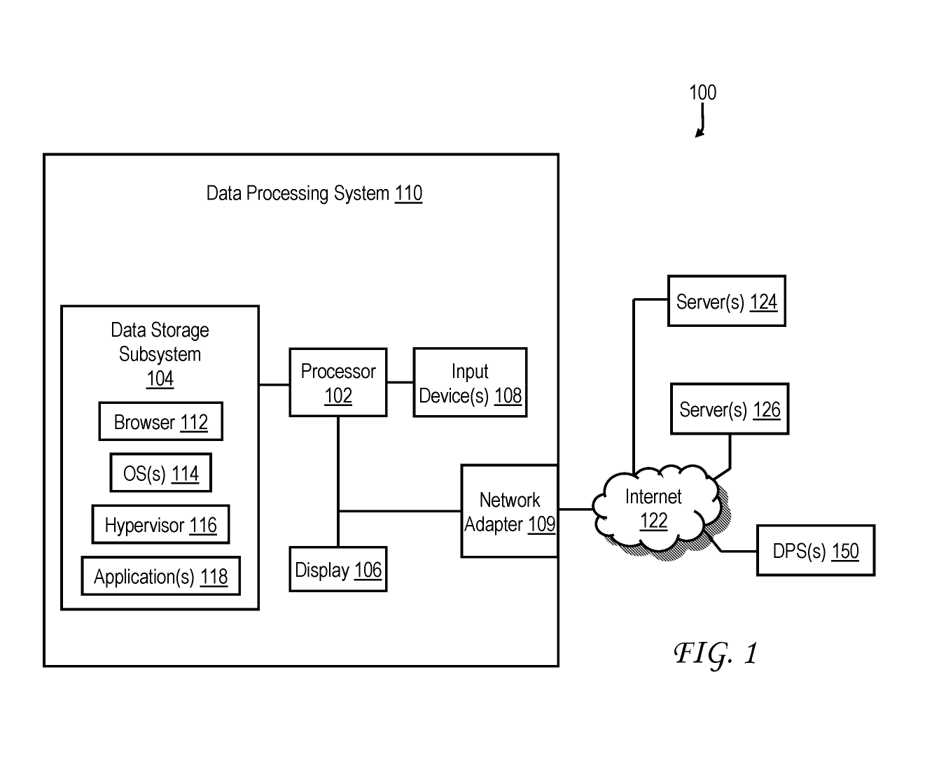

With reference to FIG. 1, an exemplary data processing environment 100 is illustrated that includes a simultaneous multithreading (SMT) data processing system 110 that is configured to restore previous values (and associated ITAGs) to registers of a register file following a processor pipeline flush, according to one or more embodiments of the present disclosure. Data processing system 110 may take various forms, such as workstations, laptop computer systems, notebook computer systems, desktop computer systems or servers and/or clusters thereof. Data processing system 110 includes one or more processors 102 (which may include one or more processor cores for executing program code) coupled to a data storage subsystem 104, optionally a display 106, one or more input devices 108, and a network adapter 109. Data storage subsystem 104 may include, for example, application appropriate amounts of various memories (e.g., dynamic random access memory (DRAM), static RAM (SRAM), and read-only memory (ROM)), and/or one or more mass storage devices, such as magnetic or optical disk drives.

Data storage subsystem 104 includes one or more operating systems (OSs) 114 for data processing system 110. Data storage subsystem 104 also includes application programs, such as a browser 112 (which may optionally include customized plug-ins to support various client applications), a hypervisor (or virtual machine monitor (VMM)) 116 for managing one or more virtual machines (VMs) as instantiated by different OS images, and other applications (e.g., a word processing application, a presentation application, and an email application) 118.

Display 106 may be, for example, a cathode ray tube (CRT) or a liquid crystal display (LCD). Input device(s) 108 of data processing system 110 may include, for example, a mouse, a keyboard, haptic devices, and/or a touch screen. Network adapter 109 supports communication of data processing system 110 with one or more wired and/or wireless networks utilizing one or more communication protocols, such as 802.x, HTTP, simple mail transfer protocol (SMTP), etc. Data processing system 110 is shown coupled via one or more wired or wireless networks, such as the Internet 122, to various file servers 124 and various web page servers 126 that provide information of interest to the user of data processing system 110. Data processing environment 100 also includes one or more data processing systems 150 that are configured in a similar manner as data processing system 110. In general, data processing systems 150 represent data processing systems that are remote to data processing system 110 and that may execute OS images that may be linked to one or more OS images executing on data processing system 110.

Those of ordinary skill in the art will appreciate that the hardware components and basic configuration depicted in FIG. 1 may vary. The illustrative components within data processing system 110 are not intended to be exhaustive, but rather are representative to highlight components that may be utilized to implement the present invention. For example, other devices/components may be used in addition to or in place of the hardware depicted. The depicted example is not meant to imply architectural or other limitations with respect to the presently described embodiments.

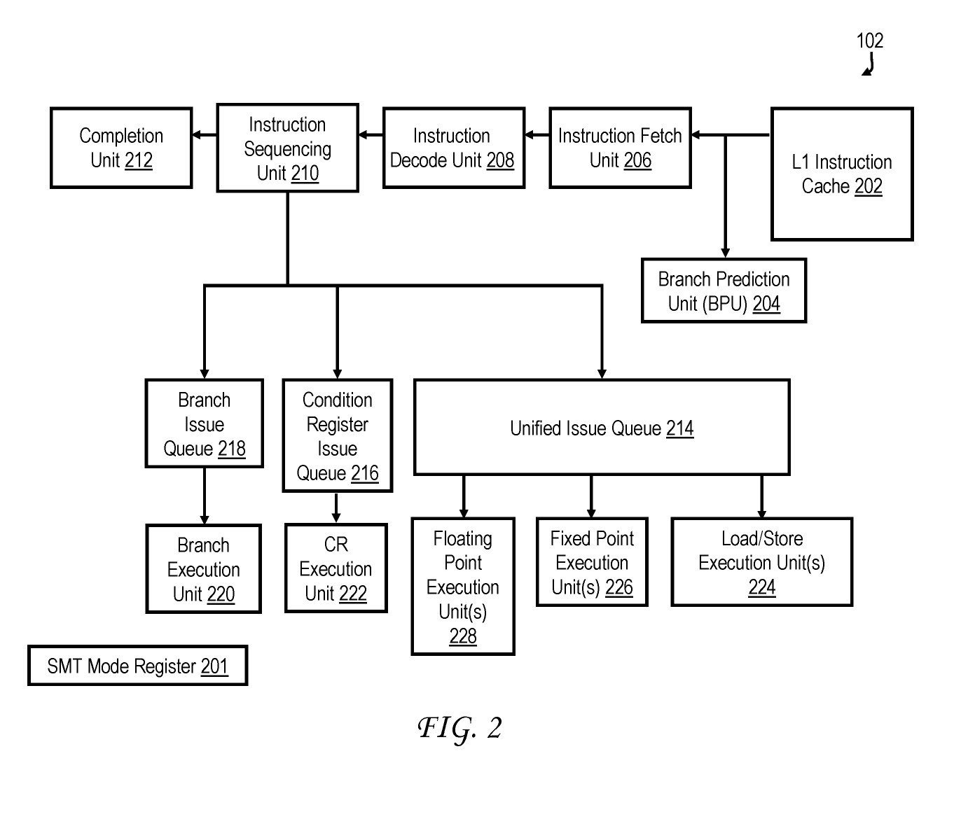

With reference to FIG. 2, relevant components of processor 102 are illustrated in additional detail. Processor 102 includes a level 1 (L1) instruction cache 202 from which instruction fetch unit (IFU) 206 fetches instructions. In one or more embodiments, IFU 206 may support a multi-cycle (e.g., three-cycle) branch scan loop to facilitate scanning a fetched instruction group for branch instructions predicted ‘taken’, computing targets of the predicted ‘taken’ branches, and determining if a branch instruction is an unconditional branch or a ‘taken’ branch. Fetched instructions are also provided to branch prediction unit (BPU) 204, which predicts whether a branch is ‘taken’ or ‘not taken’ and a target of predicted ‘taken’ branches.

In one or more embodiments, BPU 204 includes a branch direction predictor that implements a local branch history table (LBHT) array, global branch history table (GBHT) array, and a global selection (GSEL) array. The LBHT, GBHT, and GSEL arrays (not shown) provide branch direction predictions for all instructions in a fetch group (that may include up to eight instructions). The LBHT, GBHT, and GSEL arrays are shared by all threads. The LBHT array may be directly indexed by bits (e.g., ten bits) from an instruction fetch address provided by an instruction fetch address register (IFAR). The GBHT and GSEL arrays may be indexed by the instruction fetch address hashed with a global history vector (GHV) (e.g., a 21-bit GHV reduced down to eleven bits, which provides one bit per allowed thread). The value in the GSEL may be employed to select between the LBHT and GBHT arrays for the direction of the prediction of each individual branch.

IFU 206 provides fetched instructions to instruction decode unit (IDU) 208 for decoding. IDU 208 provides decoded instructions to instruction sequencing unit (ISU) 210 for dispatch. In one or more embodiments, ISU 210 is configured to dispatch instructions to various issue queues, rename registers in support of out-of-order execution, issue instructions from the various issues queues to the execution pipelines, complete executing instructions, and handle exception conditions. In various embodiments, ISU 210 is configured to dispatch instructions on a group basis. In single thread (ST) mode, ISU 210 may dispatch a group of up to eight instructions per cycle. In simultaneous multi-thread (SMT) mode, ISU 210 may dispatch two groups per cycle from two different threads and each group can have up to four instructions. It should be appreciated that in various embodiments, all resources (e.g., renaming registers and various queue entries) must be available for the instructions in a group before the group can be dispatched. In one or more embodiments, an instruction group to be dispatched can have at most two branch and six non-branch instructions from the same thread in ST mode. In one or more embodiments, if there is a second branch the second branch will be the last instruction in the group. In SMT mode, each dispatch group can have at most one branch and three non-branch instructions.

In one or more embodiments, ISU 210 employs an instruction completion table (ICT) that tracks information for each of two-hundred fifty-six (256) instruction operations (IOPs). It should be appreciated that a single instruction may be translated into multiple IOPs. In one or more embodiments, flush generation for the core is handled by ISU 210. For example, speculative instructions may be flushed from an instruction pipeline due to branch misprediction, load/store out-of-order execution hazard detection, execution of a context synchronizing instruction, and exception conditions. ISU 210 assigns instruction tags (ITAGs) to manage the flow of instructions. Instructions are issued speculatively, and hazards can occur, for example, when a fixed-point operation dependent on a load operation is issued before it is known that the load operation misses a data cache. On a mis-speculation, the instruction is rejected and re-issued a few cycles later.

Following execution of dispatched instructions, ISU 210 provides the results of the executed dispatched instructions to completion unit 212. Depending on the type of instruction, a dispatched instruction is provided to branch issue queue 218, condition register (CR) issue queue 216, or unified issue queue 214 for execution in an appropriate execution unit. Branch issue queue 218 stores dispatched branch instructions for branch execution unit 220. CR issue queue 216 stores dispatched CR instructions for CR execution unit 222. Unified issued queue 214 stores instructions for floating point execution unit(s) 228, fixed point execution unit(s) 226, load/store execution unit(s) 224, among other execution units. Processor 102 also includes an SMT mode register 201 whose bits may be modified by hardware or software (e.g., an operating system (OS)). It should be appreciated that units that are not necessary for an understanding of the present disclosure have been omitted for brevity and that described functionality may be located in a different unit.

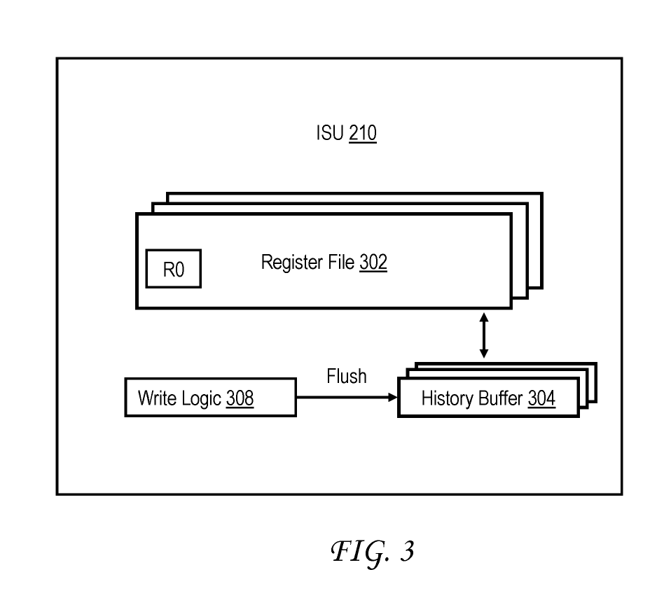

With reference to FIG. 3, ISU 210 is illustrated as including one or more register files 302, one or more history buffers 304, and write logic 308. As is discussed in further detail below, write logic 308 is configured to determine ITAGs for instructions that write to registers (e.g., register ‘0’ (R0)) in register files 302 and provide the ITAGs and previous data to history buffer 304 for storage in the event a pipeline flush is later indicated. According to the present disclosure, an ITAG of a first instruction (e.g., a first ITAG) that is updating a register and an ITAG of a second instruction (e.g., a second ITAG) that created a previous value to be stored in a history buffer are saved in association with each history buffer entry. In various embodiments, a previous value stored in a history buffer only needs to be restored to a register if a flush ITAG (i.e., an ITAG of the oldest instruction that is flushed) is older than the first ITAG of the first instruction that updated the register and the flush ITAG is younger than the second ITAG of the second instruction that created the previous value. While only a single register ‘R0’ is illustrated in FIG. 3 for brevity, it should be appreciated that register file 302 includes more than one register.

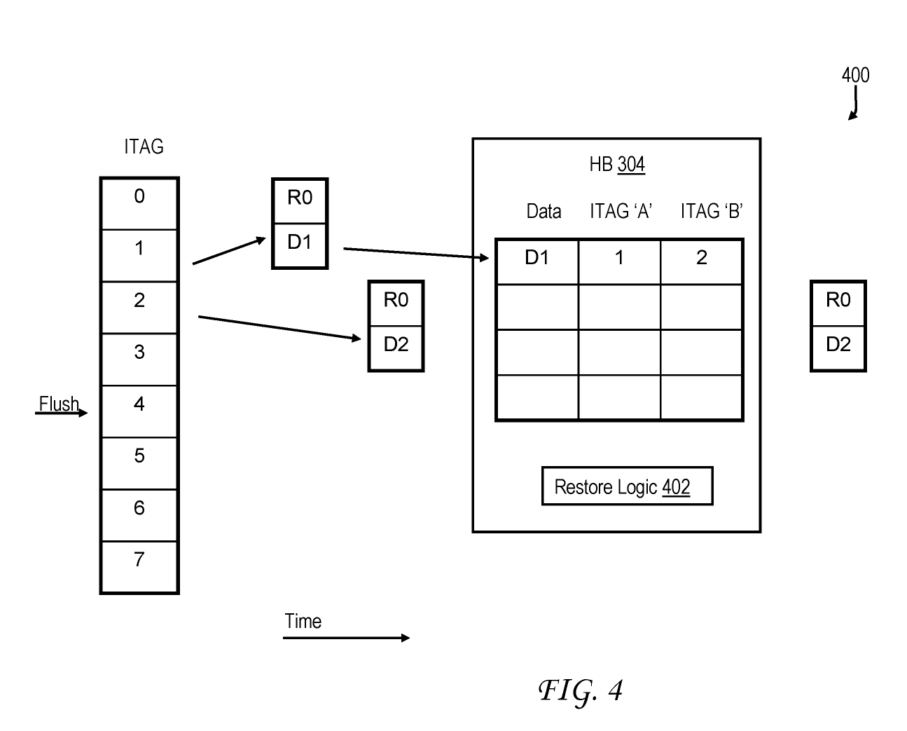

With reference to FIG. 4, a diagram 400 illustrates ITAGs for eight instructions (i.e., ITAGs 0-7, with ITAG ‘0’ corresponding to the oldest instruction and ITAG ‘7’ corresponding to the youngest instruction) that are being executed in a processor pipeline. As is shown, the instructions having ITAGs ‘1’ and ‘2’ both initiate writes to register ‘R0’. More specifically, the instruction assigned ITAG ‘1’ initiates writing data ‘D1’ to register ‘R0’ and the instruction assigned ITAG ‘2’ initiates writing data ‘D2’ to register ‘R0’, causing previous data ‘D1’ and ITAGs ‘1’ and ‘2’ to be written in a first entry in history buffer (HB) 304 for register ‘R0’ in the event that a pipeline flush later requires restoring data ‘D1’ to register ‘R0’. In various embodiments, restore logic 402 is configured to determine, as is further described below, whether previous data requires restoring from history buffer 304 to a register in register file 302. In one embodiment, each register has assigned history buffer entries. In another embodiment, a register identifier (not shown) is also stored in association with data and ITAGs of each history buffer entry.

As is also illustrated, the instruction assigned ITAG ‘4’ has caused a pipeline flush to be initiated. According to the present disclosure, a process is implemented by ISU 210 in response to the flush indication that determines whether the data ‘D1’ is to be restored to register ‘R0’. As noted above, a previous value stored in history buffer 304 only needs to be restored to a register if a flush ITAG (i.e., an ITAG of the oldest instruction that is flushed) is older than an ITAG of a first instruction (labeled “ITAG B”) that updated the register and the flush ITAG is younger than an ITAG of a second instruction (labeled “ITAG A”) that created the previous value. In diagram 400, the ITAG of the oldest instruction that is to be flushed is ‘4’, which is younger than the ITAG (i.e., ITAG ‘2’) of the first instruction that updated register ‘R0’ and is younger than the ITAG (i.e., ITAG ‘1’) of the second instruction that created the previous value ‘D1’ stored in history buffer 304 for register ‘R0’. As such, register ‘R0’ does not require restoring and the current value (i.e., data ‘D2’) in register ‘R0’ is the value that register ‘R0’ should hold following a pipeline flush (as only younger instructions with ITAGs 4-8 are flushed).

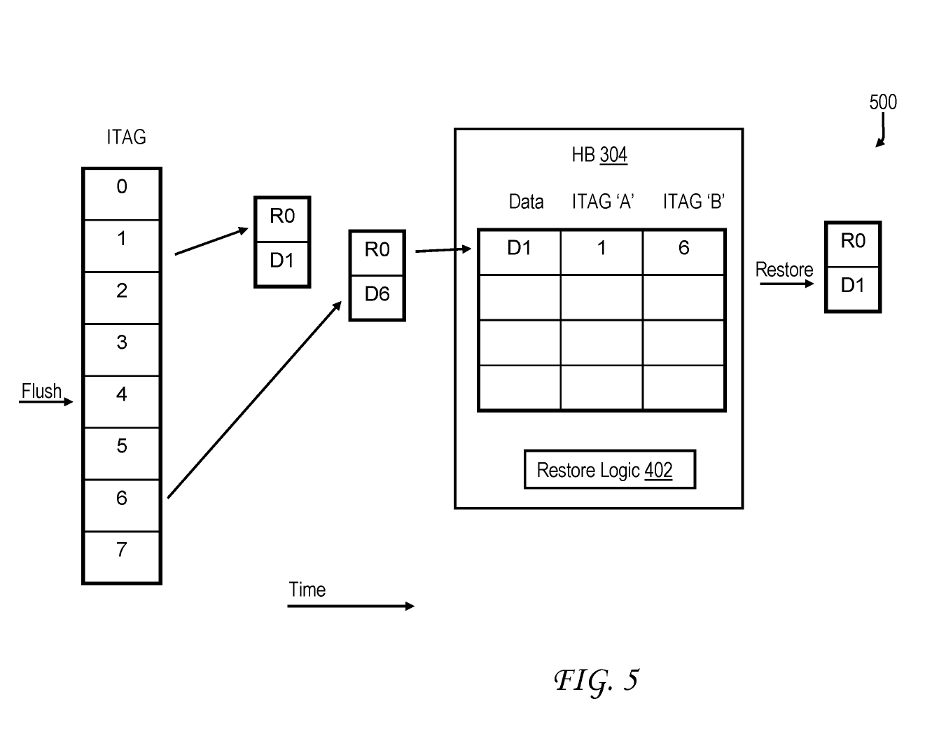

With reference to FIG. 5, a diagram 500 also illustrates ITAGs for eight instructions (i.e., ITAGs 0-7, with ITAG 0 corresponding to the oldest instruction and ITAG 7 corresponding to the youngest instruction) that are being executed in a processor pipeline. As is shown, the instructions having ITAGs ‘1’ and ‘6’ both initiate writes to register ‘R0’. More specifically, the instruction assigned ITAG ‘1’ initiates writing data ‘D1’ to register ‘R0’ and the instruction assigned ITAG ‘6’ initiates writing data ‘D6’ to register ‘R0’, causing previous data ‘D1’ and ITAGs ‘1’ and ‘6’ to be written in a first entry in history buffer (HB) 304 for register ‘R0’ in the event that a pipeline flush later requires restoring data ‘D1’ to register ‘R0’. As is also illustrated, the instruction assigned ITAG ‘4’ has again caused a pipeline flush to be initiated.

According to the present disclosure, a process is implemented by ISU 210 in response to the flush indication that determines whether the data ‘D1’ is to be restored to register ‘R0’. As previously noted, a previous value stored in history buffer 304 only needs to be restored to a register if a flush ITAG (i.e., an ITAG of the oldest instruction that is flushed) is older than an ITAG of the first instruction (labeled “ITAG B”) that updated the register and the flush ITAG is younger than an ITAG of the second instruction (labeled “ITAG A”) that created the previous value. In diagram 500, the ITAG of the oldest instruction that is to be flushed is ‘4’, which is older than the ITAG (i.e., ITAG ‘6’) of the first instruction that updated register ‘R0’ and is younger than the second ITAG (i.e., ITAG ‘1’) of the second instruction that created the previous value ‘D1’ stored in a first entry of history buffer 304 for register ‘R0’. As such, register ‘R0’ requires restoring the previous value (i.e., data ‘D1’) to register ‘R0’, as the current value (i.e., data ‘D6’) in register ‘R0’ is not the value that register ‘R0’ should hold following a pipeline flush (as the instruction with the ITAG ‘6’ requires flushing).

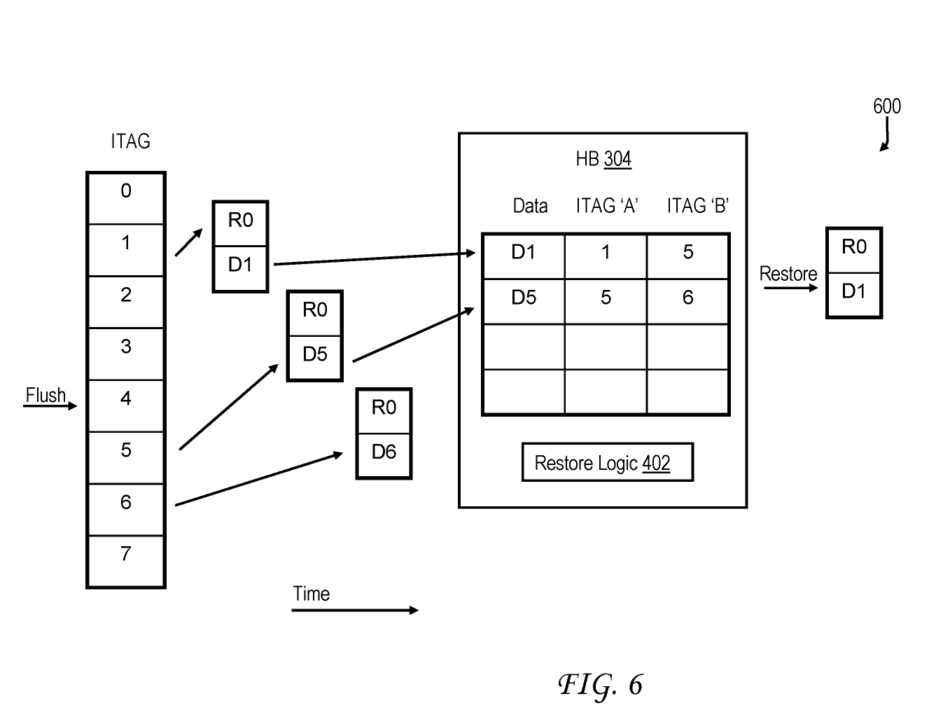

With reference to FIG. 6, a diagram 600 also illustrates ITAGs for eight instructions (i.e., ITAGs 0-7, with ITAG ‘0’ corresponding to the oldest instruction and ITAG ‘7’ corresponding to the youngest instruction) that are being executed in a processor pipeline. As is shown, the instructions having ITAGs ‘1’, ‘5’, and ‘6’ initiate writes to register ‘R0’. More specifically, the instruction assigned ITAG ‘1’ initiates writing data ‘D1’ to register ‘R0’ and the instruction assigned ITAG ‘5’ initiates writing data ‘D5’ to register ‘R0’, causing previous data ‘D1’ and ITAGs ‘1’ and ‘5’ to be written in a first entry in history buffer (HB) 304 for register ‘R0’ in the event that a pipeline flush later requires restoring data ‘D1’ to register ‘R0’. Additionally, the instruction assigned ITAG ‘6’ initiates writing data ‘D6’ to register ‘R0’, causing previous data ‘D5’ and ITAGs ‘5’ and ‘6’ to be written in a second entry in history buffer 304 for register ‘R0’ in the event that a pipeline flush later requires restoring data ‘D5’ to register ‘R0’.

As is also illustrated, the instruction assigned ITAG ‘4’ has again caused a pipeline flush to be initiated. According to the present disclosure, a process is implemented by ISU 210 in response to the flush indication that determines whether the data ‘D1’ or the data ‘D5’ is to be restored to register ‘R0’. As previously noted, a previous value stored in history buffer 304 only needs to be restored to a register if a flush ITAG (i.e., an ITAG of the oldest instruction that is flushed) is older than an ITAG of a first instruction (labeled “ITAG B”) that updated the register and the flush ITAG is younger than an ITAG of a second instruction (labeled “ITAG A”) that created the previous value. With reference to the second entry in history buffer 304 of diagram 600, the ITAG of the oldest instruction that is to be flushed is ‘4’, which is older than the ITAG (i.e., ITAG ‘6’) of the first instruction that updated register ‘R0’ and is also older than the ITAG (i.e., ITAG ‘5’) of the second instruction that created the previous value ‘D5’ stored in the second entry of history buffer 304 for the register ‘R0’. As such, register ‘R0’ does not require restoring the register ‘R0’ with the previous value (i.e., data ‘D5’) stored in the second entry of history buffer 304 (as the instruction with the ITAG ‘5’ is also flushed).

With reference to the first entry in history buffer 304 of diagram 600, the ITAG of the oldest instruction that is to be flushed is ‘4’, which is older than the ITAG (i.e., ITAG ‘5’) of the first instruction that updated register ‘R0’ and is younger than the ITAG (i.e., ITAG ‘1’) of the second instruction that created the previous value ‘D1’ stored in the first entry of history buffer 304 for the register ‘R0’. As such, the previous value (i.e., data ‘D1’) needs to be restored to register ‘R0’, as the current value (i.e., data ‘D6’) in register ‘R0’ is not the value that register ‘R0’ should hold following a pipeline flush (as instructions with ITAGs ‘5’ and ‘6’ are both flushed). As such, according to one embodiment of the present disclosure, history buffer 304 only provides data ‘D1’ to register file 302 for restoration to register ‘R0’ following the flush indication.

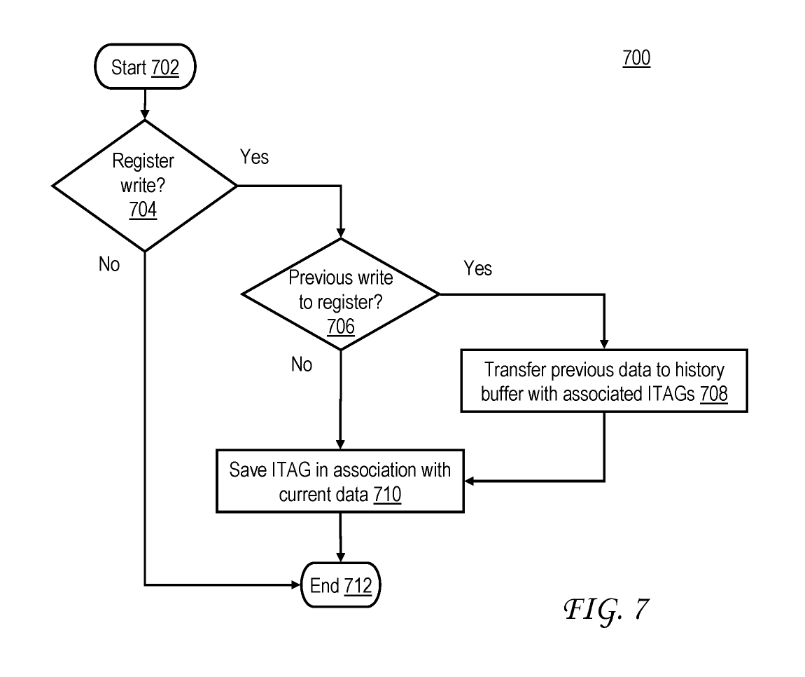

With reference to FIG. 7, an exemplary process 700 for determining whether a value associated with a register write operation to a register of register file 302 should be written to an entry in history buffer 304, according to an embodiment of the present disclosure, is illustrated. Process 700 is initiated in block 702 by, for example, write logic 308 in response to, for example, receipt of a register read operation or a register write operation for a register of register file 302. Next, in decision block 704, write logic 308 determines whether the received operation is a register read operation or a register write operation. In response to the received operation not being a register write operation in block 704 control transfers to block 712, where process 700 terminates. In response to the received operation being a register write operation in block 704 control transfers to decision block 706, where write logic 308 determines whether there was a previous register write operation to a same register associated with a current register write operation.

In response to the received operation not being a register write operation to a register that had a previous register write operation control transfers from block 706 to block 710. In block 710 write logic 308 saves an ITAG associated with the current register write operation in association with saving current data associated with the register write operation to a register of register file 302. In general, when a register of register file 302 is being updated, ISU 210 marks the register as pending and places an ITAG of the instruction that is updating the register in a field of the register. When the instruction associated with the ITAG provides an associated result, the result (data) is stored in the register. In response to the ITAG associated with the register completing, the ITAG is marked as invalid (which implies there is no live instruction updating the register). From block 710 control transfers to block 712. In response to the received operation being a register write operation to a register that had a previous register write operation in block 706 control transfers to block 708, where write logic 308 initiates transfer of previous data in the register to history buffer 304 with associated ITAGs (i.e., the ITAG of the instruction associated with the register write operation of the previous value to the register and the ITAG of the instruction associated with the register write operation of the current value to the register). It should be appreciated that history buffer 304 is required to allocate an entry for the ITAGs and associated data. From block 708 control transfers to block 710 and then block 712.

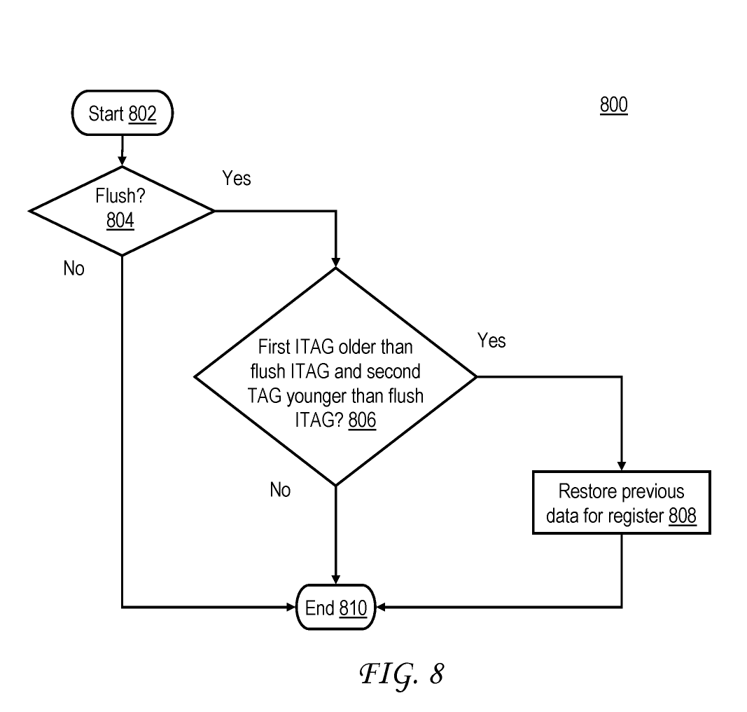

With reference to FIG. 8, an exemplary process 800 for determining whether a previous value (and an associated ITAG) written to a register of register file 302 needs to be restored from history buffer 304 to register file 302 following a pipeline flush, according to an embodiment of the present disclosure, is illustrated. Process 800 is initiated in block 802 by, for example, restore logic 402 in response to, for example, receipt of a control signal (e.g., a flush signal from write logic 308). Next, in decision block 804, restore logic 402 determines whether the received control signal is a flush signal. In response to the received control signal not being a flush signal in block 804 control transfers to block 810, where process 800 terminates. In response to the received control signal being a flush signal in block 804 control transfers to decision block 806. In block 806 restore logic 402 determines whether a previous value stored in history buffer 304 needs to be restored to register file 302.

A previous value stored in history buffer 304 only needs to be restored to a register in register file 302 if a flush ITAG (i.e., an ITAG of the oldest instruction that is flushed) is older than a first ITAG of a first instruction (labeled “ITAG B” in FIGS. 4-6) that updated the register and the flush ITAG is younger than a second ITAG of a second instruction (labeled “ITAG A” in FIGS. 4-6) that created the previous value. In response to the flush ITAG not being older than the first ITAG of the first instruction that updated the register and younger than the second ITAG of the second instruction that created the previous value control transfers from block 806 to block 810. In response to the flush ITAG being older than the first ITAG of the first instruction that updated the register and younger than the second ITAG of the second instruction that created the previous value control transfers from block 806 to block 808. In block 808 history buffer 304 initiates restoring the previous value (and an associated ITAG) for the register to register file 302 (by returning the previous value and the associated ITAG to register file 302). From block 808 control transfers to block 810. It should be appreciated that process 800 may be executed in parallel for each entry in history buffer 304 and that when multiple history buffers are implemented that each history buffer 304 may execute process 800 in parallel.

Accordingly, techniques have been disclosed herein that advantageously more efficiently restore previous values to registers of a register file in a simultaneous multithreading data processing system.

In the flow charts above, the methods depicted in the figures may be embodied in a computer-readable medium containing computer-readable code such that a series of steps are performed when the computer-readable code is executed on a computing device. In some implementations, certain steps of the methods may be combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing, but does not include a computer-readable signal medium. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible storage medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage subsystems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of operating a processor, comprising:
receiving, by a history buffer, a flush tag associated with an oldest instruction to be flushed from a processor pipeline;
in response to the flush tag being older than a first instruction tag that identifies a first instruction associated with a current value stored in a register of a register file and younger than a second instruction tag that identifies a second instruction associated with a previous value that was stored in the register of the register file, transferring, by the history buffer, the previous value for the register to the register file; and
in response to the flush tag not being older than the first instruction tag and younger than the second instruction tag, not transferring, by the history buffer, the previous value for the register to the register file.

2. The method of claim 1, further comprising:
transferring, by the register file, the previous value from the register of the register file to the history buffer in association with the first and second instruction tags.

3. The method of claim 1, wherein the current value is a speculative value.

4. The method of claim 1, wherein the first and second instructions are both associated with write operations.

5. The method of claim 1, wherein the history buffer includes multiple entries for the register, each of the multiple entries store previous values, and only one of the previous values is transferred to the register file.

6. The method of claim 1, wherein the history buffer includes multiple entries for the register, each of the multiple entries store previous values, the first instruction is older than the flush instruction, and none of the previous values are transferred to the register file.

7. The method of claim 6, wherein the register file maintains the current value in the register following the pipeline flush.

8. An instruction sequencing unit for a processor, comprising:
a register file; and
a history buffer coupled to the register file, wherein the history buffer is configured to:
receive a flush tag associated with an oldest instruction to be flushed from a processor pipeline;
in response to the flush tag being older than a first instruction tag that identifies a first instruction associated with a current value stored in a register of the register file and younger than a second instruction tag that identifies a second instruction associated with a previous value that was stored in the register of the register file, transfer the previous value for the register to the register file; and
in response to the flush tag not being older than the first instruction tag and younger than the second instruction tag, not transfer the previous value for the register to the register file.

9. The processor of claim 8, wherein the register file is configured to transfer the previous value from the register of the register file to the history buffer in association with the first and second instruction tags.

10. The processor of claim 8, wherein the current value is a speculative value.

11. The processor of claim 8, wherein the first and second instructions are both associated with write operations.

12. The processor of claim 8, wherein the history buffer includes multiple entries for the register, each of the multiple entries store previous values, and only one of the previous values is transferred to the register file.

13. The processor of claim 8, wherein the history buffer includes multiple entries for the register, each of the multiple entries store previous values, the first instruction is older than the flush instruction, and none of the previous values are transferred to the register file.

14. The processor of claim 13, wherein the register file maintains the current value in the register following the pipeline flush.

15. A data processing system, comprising:
a data storage subsystem; and
a processor coupled to the data storage subsystem, wherein the processor includes a register file coupled to a history buffer, and wherein the history buffer is configured to:
receive a flush tag associated with an oldest instruction to be flushed from a processor pipeline;
in response to the flush tag being older than a first instruction tag that identifies a first instruction associated with a current value stored in a register of the register file and younger than a second instruction tag that identifies a second instruction associated with a previous value that was stored in the register of the register file, transfer the previous value for the register to the register file; and
in response to the flush tag not being older than the first instruction tag and younger than the second instruction tag, not transfer the previous value for the register to the register file.

16. The data processing system of claim 15, wherein the register file is configured to transfer the previous value from the register of the register file to the history buffer in association with the first and second instruction tags.

17. The data processing system of claim 15, wherein the current value is a speculative value.

18. The data processing system of claim 15, wherein the first and second instructions are both associated with write operations.

19. The data processing system of claim 15, wherein the history buffer includes multiple entries for the register, each of the multiple entries store previous values, and only one of the previous values is transferred to the register file.

20. The data processing system of claim 15, wherein the history buffer includes multiple entries for the register, each of the multiple entries store previous values, the first instruction is older than the flush instruction, and none of the previous values are transferred to the register file.
